(19) United States
(12) Patent Application Publication
(10) Pub. No.: US 2002/0069048 A1
(43) Pub. Date: Jun. 6, 2002

(54) Communication system

(76) Inventors: Deepak Kishinchand Sadhwani, Colombo (LK); Deepak Ramnani, Colombo (LK)

Correspondence Address: Mark R. Wisner, c/o Wisner & Associates, Suite 930, 2925 Briarpark, Houston, TX, 77042-3728, US

(21) Appl. No.: 09/829,234

(22) Filed: Apr. 9, 2001

Related U.S. Application Data
(63) Continuation-in-part of application No. PCT/SG00/00046, filed on Apr. 7, 2000.

(51) Int. Cl. G06F 17/28

(52) U.S. Cl. 704/3

(57) ABSTRACT

A communication system for communicating information between an information source and an information recipient which includes means for optionally directly converting information from a primary language to a secondary language. More particularly, the present invention provides a communication system which enables messages sent by phone, facsimile, email, pager, SMS or other means to be converted into an alternative format and/or language and either stored or forwarded to an information recipient.

### CROSS REFERENCE TO RELATED APPLICATION

The present application is a continuation-in-part of prior co-pending International Application No. PCT/ISG00/00046, filed Apr. 7, 2000, and entitled COMMUNICATION SYSTEM.

### FIELD OF THE INVENTION

The present invention relates to communication systems and, in particular, relates to a communication system for communicating information between an information source and an information recipient which includes means for directly converting information from a primary language to a secondary language. Even more particularly, the present invention provides a communication system which enables messages sent by phone, facsimile, email, pager, short messaging system (SMS) or other means to be converted into an alternative language and either stored or forwarded to an information recipient.

### BACKGROUND OF THE INVENTION

Current communication technologies such as telephone, facsimile, email, pager and SMS each have their unique way of forwarding information from an information source to an information recipient. Because each of these communication means have their separate individual delivery channels and formats, messages and other information must currently be received in the same format and language they are sent in. The technology is not currently on the market to enable virtually any format of communication to be converted and received in an alternative language.

### OBJECTS OF THE INVENTION

It is therefore one non-limiting object of the present invention to provide a communication system that enables users to store, retrieve and access messages using multiple delivery channels to maximise mobility, flexibility and convenience.

It is another non-limiting object of the present invention to provide a communication system which allows users to check email, voice mail, faxes and ICQ messaging via a regular phone with a voice-driven menu system, or via the Internet using a web-based administration tool.

It is an additional non-limiting object of the present invention to provide a communication system which provides on-line translations from one language to another in voice recorded form.

It is yet another non-limiting object of the present invention to provide a communication system which is accessible using a regular telephone, and which links multiple communication means including but not limited to telephone, fax, email, pager, SMS, and ICQ.

Other objects, and the advantages, of the present invention will be made apparent to those skilled in the art by the following description of a preferred embodiment thereof.

### SUMMARY OF THE INVENTION

Accordingly there is provided, according to one aspect of the present invention, a communication system for communicating information between an information source and an information recipient including:

information receiving means for receiving information in an audible format and

information converting means for converting said information directly from a primary language to a secondary language without first converting said information into a textual format.

Preferably, said audible format includes any humanly audible format other than a facsimile format.

Preferably, said primary language is any human language which can be represented audibly.

Preferably, said secondary language is any human language which can be represented audibly.

Preferably, the communication described above further includes storage means for storing information.

Preferably, the communication described above further includes forwarding means for forwarding information to an information recipient.

Preferably, said audible format includes any one of voicemail format, landline telephone format, digital mobile phone format, analogue mobile phone format, or other recorded voice format.

Preferably, said primary language includes any the one of the official languages of Albania, Algeria, Angola, Antigua and Barbuda, Argentina, Armenia, Australia, Austria, Azerbaijan, Bahamas, Bahrain, Bangladesh, Barbados, Belaus, Belgium, Belize, Benin, Bolivia, Bosnia and Herzegovina, Botswana, Brazil, Bulgaria, Bukina Faso, Burundi, Cambodia, Cameroon, Canada, Central African Republic, Chad, Chile, China, Colombia, Congo, Congo, Democratic Republic of, Costa Rica, Cote d'Ivoire, Croatia, Cuba, Cyprus, Czech Republic, Denmark (including Faroe Islands), Djibouti, Dominica, Dominican Republic, Ecuador, Egypt, El Salvador, Estonia, Equatorial Guinea, Finland, Fiji, France (including Overseas Departments and Territories), Gabon, Gambia, Georgia, Germany, Ghana, Greece, Grenada, Guatemala, Guinea, Guinea-Bissau, Guyana, Haiti, Holy See (The Vatican), Honduras, Hong Kong, China, Hungary, Iceland, India, Indonesia, Iran, Islamic Republic of, Iraq, Ireland, Israel, Italy, Jamaica, Japan, Jordan, Kakakahstan, Kenya, Korea, Democratic People's Republic of, Korea, Republic of (South Korea), Kuwait, Kyrgyzstan, Laos, Lebanon, Lesotho, Liberia, Libya, Liechtenstein, Lithuania, Luxembourg, Macau, Macedonia (former Yugoslavia), Madagascar, Malawi, Malaysia, Maldives, Mali, Malta, Mauritania, Mauritius, Mexico, Moldova, Monaco, Mongolia, Morocco, Mozambique, Myanmar, Namibia, The Netherlands, New Zealand, Nicaragua, Niger, Nigeria, Norway, Oman, Pakistan, Panama, Papua New Guinea, Paraguay, Peru, Philippines, Poland, Portugal, Qatar, Romania, Russian Federation, Rwanda, Saint Kitts and Nevis, Saint Lucia, Saint Vincent and the Grenadines, San Marino, Sao Tome and Principe, Senegal, Sierra Leone, Singapore, Slovak Republic (Slovakia), Slovenia, Solomon Islands, South Africa, Spain, Sri Lanka, Sudan, Suriname, Swaziland, Sweden, Switerland, Syrian Arab Republic (Syria), Taiwan, Tajikistan, Tanzania, Thailand, Togo, Trinidad and Tobago, Tunisia, Turkey, Turkmenistan, Uganda, Ukraine, United Arab Emirates, United Kingdom (including Isle of Man), United States Of America (including all territories and possessions, including the Commonwealth of Puerto Rico), Uruguay, Uzbekistan, Venezuela, Vietnam, Yugoslavia (including Serbia and Montenegro), Zambia or Zimbabwe.

Preferably, said secondary language includes any the one of the official languages of Albania, Algeria, Angola, Antigua and Barbuda, Argentina, Armenia, Australia, Austria, Azerbaijan, Bahamas, Bahrain, Bangladesh, Barbados, Belaus, Belgium, Belize, Benin, Bolivia, Bosnia and Herzegovina, Botswana, Brazil, Bulgaria, Bukina Faso, Burundi, Cambodia, Cameroon, Canada, Central African Republic, Chad, Chile, China, Colombia, Congo, Congo, Democratic Republic of, Costa Rica, Cote d'Ivoire, Croatia, Cuba, Cyprus, Czech Republic, Denmark (including Faroe Islands), Djibouti, Dominica, Dominican Republic, Ecuador, Egypt, El Salvador, Estonia, Equatorial Guinea, Finland, Fiji, France (including Overseas Departments and Territories), Gabon, Gambia, Georgia, Germany, Ghana, Greece, Grenada, Guatemala, Guinea, Guinea-Bissau, Guyana, Haiti, Holy See (The Vatican), Honduras, Hong Kong, China, Hungary, Iceland, India, Indonesia, Iran, Islamic Republic of, Iraq, Ireland, Israel, Italy, Jamaica, Japan, Jordan, Kakakahstan, Kenya, Korea, Democratic People's Republic of, Korea, Republic of (South Korea), Kuwait, Kyrgyzstan, Laos, Lebanon, Lesotho, Liberia, Libya, Liechtenstein, Lithuania, Luxembourg, Macau, Macedonia (former Yugoslavia), Madagascar, Malawi, Malaysia, Maldives, Mali, Malta, Mauritania, Mauritius, Mexico, Moldova, Monaco, Mongolia, Morocco, Mozambique, Myanmar, Namibia, The Netherlands, New Zealand, Nicaragua, Niger, Nigeria, Norway, Oman, Pakistan, Panama, Papua New Guinea, Paraguay, Peru, Philippines, Poland, Portugal, Qatar, Romania, Russian Federation, Rwanda, Saint Kitts and Nevis, Saint Lucia, Saint Vincent and the Grenadines, San Marino, Sao Tome and Principe, Senegal, Sierra Leone, Singapore, Slovak Republic (Slovakia), Slovenia, Solomon Islands, South Africa, Spain, Sri Lanka, Sudan, Suriname, Swaziland, Sweden, Switerland, Syrian Arab Republic (Syria), Taiwan, Tajikistan, Tanzania, Thailand, Togo, Trinidad and Tobago, Tunisia, Turkey, Turkmenistan, Uganda, Ukraine, United Arab Emirates, United Kingdom (including Isle of Man), United States Of America (including all territories and possessions, including the Commonwealth of Puerto Rico), Uruguay, Uzbekistan, Venezuela, Vietnam, Yugoslavia (including Serbia and Montenegro), Zambia or Zimbabwe.

According to another aspect of the present invention there is disclosed a method of using the communication system described above including the following steps:

(a) sending information in an audible format to said information receiving means;

(b) converting said information from a primary language to a secondary language via said information converting means; and

(c) forwarding said information in said audible format and said secondary language to said information recipient via said information forwarding means.

### BRIEF DESCRIPTION OF THE DRAWINGS

A preferred embodiment of the present invention will now be described with reference to the drawings in which:

FIG. 1 is a schematic diagram of a preferred embodiment of a communication system constructed in accordance with the teachings of the present invention.

FIG. 2 is a flow diagram illustrating the information processing sequence of the preferred embodiment of the communication system of the present invention shown in FIG. 1, when accessed via a telephone.

FIG. 3 is a flow diagram illustrating the second stage of the menu sequence of the preferred embodiment of the communication system of the present invention shown in FIG. 1, when accessed via a telephone.

FIG. 4 is an alternative view of both stages of the menu sequence illustrated in FIGS. 2 and 3.

### DETAILED DESCRIPTION OF THE PREFERRED EMBODIMENT

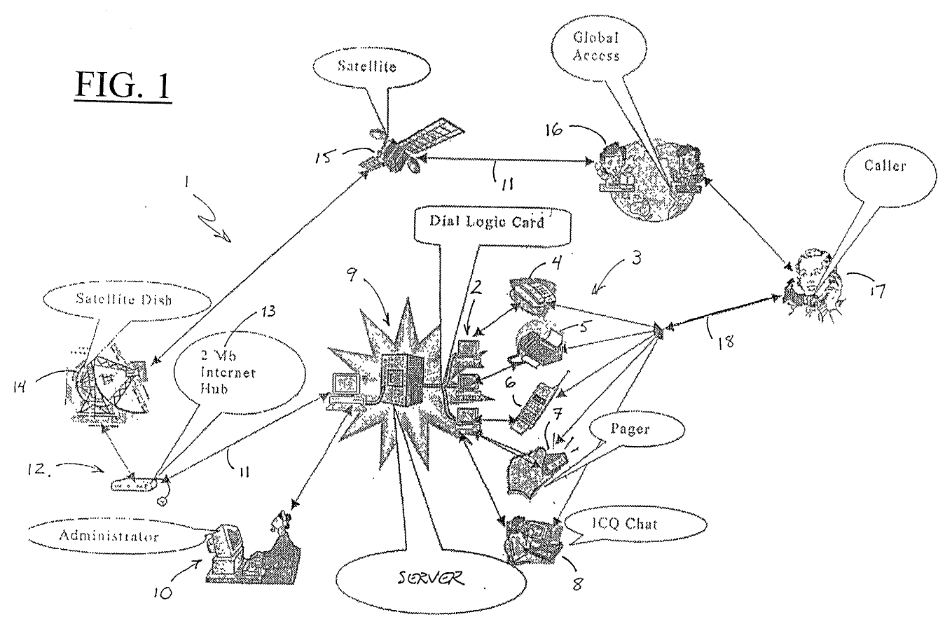

As shown in FIG. 1, the preferred embodiment of a communication system (1) constructed in accordance with the teachings of the present invention includes means (2) for receiving information (represented by the arrows 18) from a plurality of communication devices (3) such as telephones (4), facsimile machines (5), mobile phones (6), pagers (7) and personal computers (8). The communication system (1) of the preferred embodiment further includes information converting means (9), which is accessible by an administrator computer (10), and which sends converted information (represented by the arrows 11) to information transmitting means (12). In this preferred embodiment, the information transmitting means (12) includes at least one Internet hub (13), at least one satellite dish (14) and at least one satellite (15) for conveying the converted information (11) from the information source (17) to the information recipient (16). Those skilled in the art who have the benefit of this disclosure will also recognize that each of the components of the communication system (1) of the present invention also includes one or more microprocessors having appropriate operating programs encoded and/or stored in the memory thereof.

In use, when the information receiving means (2) receives information (18) from a communication device (3), it forwards the information (18) to the information converting means (9). The information (18) arrives in a primary format (25) (such as fax format, email format, voice message format, etc) and in a primary language (27) such as English. The information converting means (9) then performs one of a variety of possible functions including:

(a) leaving the information (18) in its primary format (25) and language (27);

(b) converting the format of the primary information (18) into an alternative format; and/or

(c) translating the content of the primary information (18) from the primary language (27) into a secondary language (28).

For example, an information source (17) may send information (18) in the form of an email, written in English, to the information receiving means (2). The primary format (25) would therefore be email format and the primary language (27) would be English. The information converting means (9) then (at the request of the information source (17) or information recipient (16)) converts the content of the English email, by doing a text to text translation into French under control of appropriate software, thus producing a French email. In this case, the secondary language is therefore French. The information converting means (9) then translates the French text email into a secondary format (26) such as an audible format. Thus the information recipient (16) retrieves the converted information (11) in its secondary format and/or language by listening to the French sound recording.

Alternatively, an information source (17) could send the information (18) in the form of a spoken English message, via a telephone (4) to the information receiving means (2). The primary format in this case would be an audible format and the primary language would be English. The information converting means (9) then directly converts the information (18) into a French spoken message using appropriate translation software. Thus the information (18) is converted from a primary language (English) into a secondary language (French) without first converting the information into a textual format.

In alternative embodiments, the information (18) in an audible primary format could be sent from a telephone (4), mobile phone (6) or via a microphone on a personal computer (8). In one preferred embodiment, the audible primary format may be converted to any one of a plurality of different languages. In one preferred embodiment, the converted spoken information could be generated in the voice pattern of either the information source (17), the information recipient (16) or a computer generated voice pattern, at the information recipient (16) or information source's (17) request.

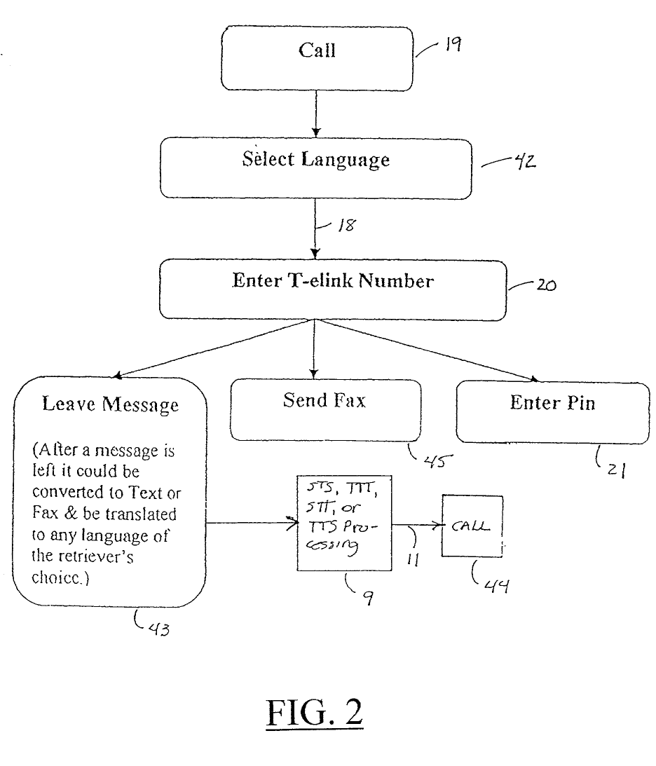

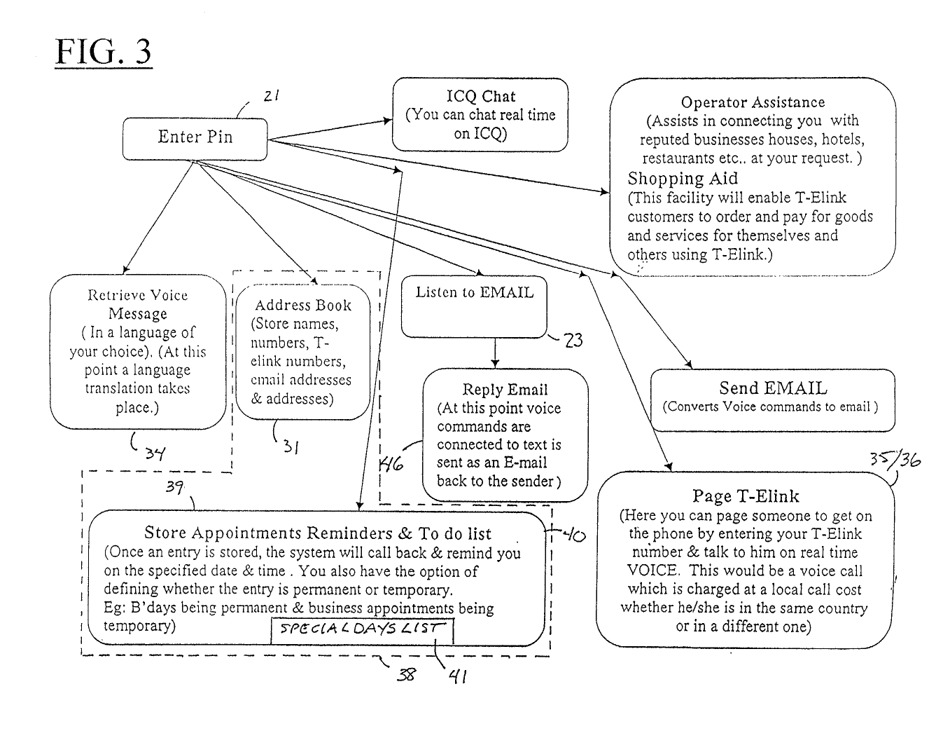

In one preferred embodiment of the present invention, an information source (17) would use the communication system (1) of the present invention via a telephone, using the steps illustrated in FIGS. 2 and 3, as follows:

The information source (17) telephones a “T-elinkTm” base or information receiving means (2) in their locality at step (19). This is a similar arrangement to a user dialing up an Internet service provider in their vicinity. Once the information source (17) has connected to the T-elink™ base (2), a recorded message then instructs the information source (17) to select the language (step 42) they wish to communicate in, preferably by pressing one or more buttons on their telephone (4) or by audible (spoken) response. The information source (17) is then prompted to enter the T-elink™ number (20) of the information recipient (16), to whom they wish to send information (18), usually in the form of a message 43. The T-elink™ number (20) is a unique number to each individual or corporation which serves as a single point to which information sources (17) can send primary information (18), and from which information recipients (16) can collect primary information (18) or converted information (11). The message is then translated from primary language to secondary language, audible format to textual format or audible format to audible format, and stored in information storage means (22) for subsequent retrieval when the recipient (not shown in FIG. 2) calls to access information processing means (9) as at step 44.

Once the information source (17) has entered the T-elink™ number (20) of the information recipient (16), they can either leave a message 43 for that person or send a fax 45 to that person. Although not shown in the FIGS. 2 and 3, the information source (17) could also send a pager message to the information recipient (16). In one preferred embodiment, the pager message is used to indicate to the information recipient (16) that they should connect to their own T-elink™ number (20) so that the information source (17) and the information recipient (16) can communicate via ICQ on-line. As illustrated in the figures, if the person entering the T-elink™ number (20) has entered their own Telink™ number, they can then enter their own personal identification number (PIN) as at step (21) in order to retrieve information (18) from the information storage means (22) of the communication system (1).

The information recipient (16), after entering their PIN (21) then listens to or views a menu of choices which preferably identifies the primary formats (25) of the messages or information (18) that have been left for them. For example, the menu could indicate that they have three English voice mail messages, six Japanese emails and two French facsimiles. In one preferred embodiment, when the information recipient (16) selects the “retrieve voice message” option, they are given a choice of secondary languages (28) in which to receive the message/information (18). If they select a secondary language (28) which is different from the primary language (27) of the information (18) which has been left, the information converting means (9) firstly changes the information (18) from voice recorded information (18) in the primary language (27) into a spoken message in the secondary language (28). For example, a voice message left in English would be directly converted into a Japanese spoken message (11) to which the information recipient (16) would listen.

In a similar way, the information recipient (16) could listen to an email (23) which has been sent to their T-elink™ number (20). In this example, the text email is converted from the textual format e-mail (23) to a spoken message in audible format by the information converting means (9). The information recipient (16) then listens to the spoken email. Preferably, the information recipient (16) is presented with a choice of secondary languages in which he/she would like to listen to the email (23). Having listened to the email (23), the information recipient (16) is then prompted by the recorded menu (24) to reply to the email or forward it to a third party. If the information recipient (16) chose to reply to the email (23) sent from an information source (17), it would then leave a primary information (18) voice message in the memory of the information storage means (22). The user could then have the choice of hearing the email read back to them, amending the email, and/or sending the email (23), all in either the primary or the secondary language.

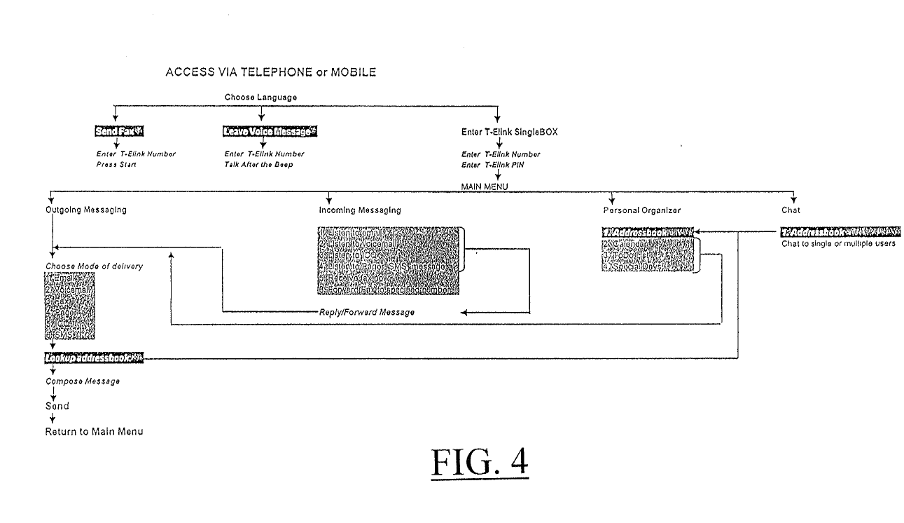

The present invention will now be described in further detail without particular reference to the figures. When a user (information source (17) or recipient (16)) accesses the system (1), he/she must first call the local access number of the server (T-elink™ base (19)) in the country or location where he is dialing. The user is given a choice of languages. Once the preferred language has been selected then the user is preferably given one or more of the following three options, illustrated in FIG. 4:

1. Leave a voicemail message for another T-elink™ customer;

2. Send a fax to another T-elink™ customer; or

3. Enter own T-elink™ messagebox (the information storage means (22)).

If the user wishes to access his/her mailbox (the information storage means (22)), the user will be requested to enter his/her message-center id and PIN number. This information is first authenticated against the message-center database (30) in a manner known in the art and then the user is presented with the following options:

1. Compose an outgoing message;

2. Check incoming messages;

3. Access personal organiser and address book;

4. VoiceChat to other message centre users; or

5. Configure and personalise the system.

Although the above embodiment has been described with reference to a user using a telephone to access the communication system, alternative means of accessing the system (1) are also available, including but not limited to access via hand-held computer/personal digital assistant (PDA), personal or laptop computer, the internet and appropriate browsers. In such embodiments, the menu options may appear as text on the screen rather than as a voice message heard via the telephone. Alternatively, the menu options are provided in an audible format heard via the user's multimedia computer with the desired option being chosen by keyboard, mouse, or other controller input, or by verbal input from the user.

When accessing the preferred embodiment of the communication system (1) of the present invention using a telephone device (4) the user (information source (17) or recipient (16)) has access to a variety of functions not currently offered by any other known system.

Preferably, the user has the option to either compose an email, send a voicemail message to another T-elink™ mailbox or even to a specific phone number as dialed, or send an ICQ, pager or SMS (short messaging system), to name a few. The information converting means (9) then converts the information (18) from the first (audible) format directly from a primary language (English, for instance) to a secondary language (for instance, French) directly, e.g., without converting the information into a textual format. The message center (information converting means (9)) then stores the information, in the secondary language, for subsequent retrieval by the user, acting as intended recipient (16). Alternatively, the message center/information converting means (9) stores the information in the information storage means (22) in the primary language and then converts the primary language directly to the secondary language at the time the user/recipient (16) checks incoming messages. The message center/information converting means (9) may also include a speech-to-text conversion facility that converts spoken words to text in order to use any of these message formats except for fax where the user simply hits the “start” button on his fax machine when provided with the fax tone message.

Conversion of information (18) from first, primary language to secondary language is accomplished in information converting means (9) using any of several known software applications for converting speech to speech (STS), speech to text (STT), text to text (TTT), and text to speech (TTS) that is stored in the memory of information converting means (9). Such software is available, for instance, from AT&T, New York, N.Y. (STS and TTS), Lucent Technologies/Bell Labs, Basking Ridge, NJ (TSS), Lernout & Hauspie, leper, Belgium (STS and TTT), and Dragonspeak Systems, Inc., Newton, MA (STT). The primary information (18) may be audible or text and, as noted above, may be stored in message center/information storage means (22) in either the primary language or in the selected secondary language as converted information (11), e.g., after processing via TTT software if the primary information (18) is audible or after processing via TTS software if the primary information (18) is textual such as an email. In the preferred embodiment, the information (18) is stored in the primary language to enable the recipient (16) to select a secondary language (for instance, from an audible menu (if the recipient (16) utilizes a telephone to retrieve the information) or a menu that is displayed on a computer or graphic display device (such as the display of a mobile telephone) so as to retrieve the information (18) as converted information (11). If the primary information is audible and the recipient chooses to retrieve the information audibly, translation to the selected secondary language is accomplished in the TTT software. If the primary information is in textual format (33) and the recipient (16) chooses to retrieve the information audibly, translation to the selected secondary language occurs either in the TTS software or the (untranslated) output from the TTS software is utilized as the input to TTT software for translation.

If information converting means (9) includes the above-described option to convert to text, the information (18) in the primary language is converted to text using STT software and the output from the STT software is used as the input to TTT software for translating from the primary language to the secondary language for subsequent retrieval by the recipient (16) via TTS software. Alternatively, translation from primary to secondary language occurs in the TTS software without using TTT software. Alternatively, the translation occurs in the STS software, the output from the STS software is used as the input for STT software, and the information (18) is stored as text for subsequent retrieval via TTS software.

Compose an Outgoing Message/Information (18)

Before the user (information source (17)) composes the message/information (18) he/she will have the option to access his/her personal address book (31) by saying the name of the information recipient(s) (16) to whom he/she wishes to send the message/information (18). In this preferred embodiment, the system (1) looks up the address book (31) for the appropriate email address, phone number or destination information as applicable depending on the type of message/information (18) being composed. However, if the information recipient(s) (16) does not have a message-compatible destination number or address, the system generates an error message or allows the user to add this information into his/her personal address book (31) at this point.

Preferably, the information converting means (9) includes a built-in spell checker and grammar checker and reads back the composed message/information (18) to the information source (17) to ensure accuracy.

The information source (17) then chooses to send the message/information (18) via the information transmitting means (12).

Receive Incoming Message/Information (18)

Having entered his/her PIN, the user has the option to act as an information recipient (16) and receive a message/information (18) which has been received by the information receiving means (2) and stored by the information converting means (9).

Stored incoming messages (18) are preferably grouped by message type, as follows:

1. Email

At the message recipient's (16) request, a received email (32) is converted from textual format (33) to an audible format (29) by the TTS software stored in the memory of information converting means (9) and is read over the phone (4) in the primary or a selected secondary language (after translation in either either textual format (33) using the TTT software stored in information converting means (9) or the TTS software) and includes the following information:

(a) Time and date—the system (1) reads time and date information;

(b) From—the system (1) reads up to four information source (17) names—otherwise, it states “multiple recipients”;

(c) Copies to—the system (1) reads up to four information recipient (16) names—otherwise, it states “multiple recipients”;

(d) Subject—the system (1) reads the subject of the email; and

(e) Body—the system (1) reads the body of the text up to a user-defined limit.

2. Voicemail

At the message recipient's (16) request, a received voicemail (34) is played over the phone (4) including the following information:

(a) Time and date—the system (1) reads time and date information

(b) Playback of message—the system (1) plays back the voicemail (34) message.

If the voicemail (34) message has been left in a primary language that the information recipient (16) does not understand, at the direction of recipient (16), the system (1) converts the primary language voicemail (34) to a secondary language (27) in an audible format (29) utilizing the above-described TTT software stored in the memory of information converting means (9).

3. Pager, SMS Messages

At the message recipient's (16) request, received Pager (35) and SMS (36) messages are converted from textual format (33) to an audible format (29) by the TTS software stored in the memory of information converting means (9) and are read over the phone (4) including the following information:

(a) Time and date—the system (1) reads time and date information;

(b) From—the system (1) reads the number of the information source (17);and

(c) Body—the system (1) reads the body of the message (18) up to a user-defined limit.

If the pager (35) or SMS (36) message has been left in a primary language that the information recipient (16) does not understand, at the direction of recipient (16), the system (1) converts the primary language message (35) or (36) to a secondary language (27) in either (a) the textual format (33) using the above-described TTT software stored in the memory of information converting means (9) and then to an audible format (29) utilizing the above-described TTS software stored in the memory of information converting means (9) or (b) the audible format (29) utilizing the primary language output from the TTS software as the input to the TTT software.

4. Receive Fax/Forward Fax

Any faxes (3) that have been received by the information receiving means (2) and stored in the message box (information storage means (22)) can be relayed to the user's current phone (4) if it has a built-in fax functionality. Alternatively, the user can automatically forward a fax to a specific number, preferably for an additional charge. Conversion of the textual format (33) fax to audible format (29) and translation from primary to secondary languages is accomplished for faxes in the same manner described above for pager (35) and SMS (36) messages.

Personal Organizer

The preferred embodiment of the present invention also includes a personal organiser (38). Preferably, the personal organiser (38) has four functions:

1. Address book—this contains name, contact numbers, fax numbers, pager and mobile numbers, SMS numbers, email addresses, mailing address and any other pertinent information relating to information recipients (16). Such personal details about information recipients (16) can be entered via global computer network (Internet or worldwide web), local computer network (Intranet), or by direct voice input using the inbuilt speech to text facility of the information converting means (9).

In the preferred embodiment these personal details can be retrieved by searching by a variety of parameters, including but not limited to name, phone number or email address, again using speech to speech, speech to text, or text to speech. Note that, in this manner, the functionality of translation of these personal details from a primary language to a secondary language is preserved, regardless of the format in which the information is retrieved.

2. Calendar—the calendar (39) of the preferred embodiment contains a list of appointments for the day, week or month. Preferably, access to the calendar (39) is obtained at least by phone or by computer (or PDA) via the Internet or Intranet. In one preferred embodiment, the calendar (39) is set to retrieve the information at a specific time to remind the user (by email, voicemail, SMS, pager or phone, in text or audible format and in a primary or secondary language) of a specific appointment, incoming message, or task.

3. To-do list—the to-do list (40) preferably contains a list of things to do for the day, week or month. Preferably, access to the to-do list (40) is obtained at least by phone or by computer (or PDA) via the Internet or Intranet. Even more preferably, the to-do list (40) can be set to remind the user (by email, voicemail, SMS, pager or phone, in text or audible format and in a primary or secondary language) of a specific thing that needs to be done.

4. Special days—The special days list (41) preferably contains a list of birthdays, anniversaries, holidays for the month, or similar events. Preferably, access to the special days list (41) is obtained at least by phone or by computer (or PDA) via the Internet or Intranet. Even more preferably, the special days list (41) can be set to remind the user (by email, voicemail, SMS, pager or phone, in text or audible format and in a primary or secondary language) of a specific appointment.

Interactive Chat Function

In the preferred embodiment of the present invention, the system (1) includes the capacity to notify an information recipient (16) or source (17) when he/she selects the interactive chat option in the menu if any of the information recipients (16) listed in his/her address book (31) are currently logged onto the system (1). If so, regardless of the geographical location of the users, a live voice chat call can be initiated between the parties or a conference call can be initiated (provided that all parties accept a call). Utilizing the TTT software resident on information converting means (9), one party to the chat inputs information in audible format (29) in that party's respective primary language and the other party/parties to the chat retrieve the primary information (18) in the secondary language(s).

Preferably, the system (1) is able to interface with other proprietary public chat domains.

Although the present invention has been described herein with reference to preferred embodiments, including diagrams, it will be appreciated by those skilled in the art that numerous modifications and variations may be made without departing from the overall spirit and scope of the invention.

1. A communication system for communicating information between an information source and an information recipient including:
information receiving means for receiving information in an audible format and
information converting means for converting said information directly from a primary language to a secondary language without first converting said information into a textual format.

2. The communication system as claimed in claim 1 wherein said audible format includes any humanly audible format other than a facsimile format.

3. The communication system as claimed in claim 1 wherein said audible format includes any one of voicemail format, landline telephone format, digital mobile phone format, analogue mobile phone format, or other recorded voice format.

4. The communication system as claimed in claim 1 further including storage means for storing information.

5. The communication system as claimed in claim 1 further including means for forwarding information to an information recipient.

6. The communication system as claimed in claim 1 wherein said primary language is any human language which can be represented audibly.

7. The communication system as claimed in claim 6 wherein said primary language includes any the one of the official languages of Albania, Algeria, Angola, Antigua and Barbuda, Argentina, Armenia, Australia, Austria, Azerbaijan, Bahamas, Bahrain, Bangladesh, Barbados, Belaus, Belgium, Belize, Benin, Bolivia, Bosnia and Herzegovina, Botswana, Brazil, Bulgaria, Bukina Faso, Burundi, Cambodia, Cameroon, Canada, Central African Republic, Chad, Chile, China, Colombia, Congo, Congo, Democratic Republic of, Costa Rica, Cote d'Ivoire, Croatia, Cuba, Cyprus, Czech Republic, Denmark (including Faroe Islands), Djibouti, Dominica, Dominican Republic, Ecuador, Egypt, El Salvador, Estonia, Equatorial Guinea, Finland, Fiji, France (including Overseas Departments and Territories), Gabon, Gambia, Georgia, Germany, Ghana, Greece, Grenada, Guatemala, Guinea, Guinea-Bissau, Guyana, Haiti, Holy See (The Vatican), Honduras, Hong Kong, China, Hungary, Iceland, India, Indonesia, Iran, Islamic Republic of, Iraq, Ireland, Israel, Italy, Jamaica, Japan, Jordan, Kakakahstan, Kenya, Korea, Democratic People's Republic of, Korea, Republic of (South Korea), Kuwait, Kyrgyzstan, Laos, Lebanon, Lesotho, Liberia, Libya, Liechtenstein, Lithuania, Luxembourg, Macau, Macedonia (former Yugoslavia), Madagascar, Malawi, Malaysia, Maldives, Mali, Malta, Mauritania, Mauritius, Mexico, Moldova, Monaco, Mongolia, Morocco, Mozambique, Myanmar, Namibia, The Netherlands, New Zealand, Nicaragua, Niger, Nigeria, Norway, Oman, Pakistan, Panama, Papua New Guinea, Paraguay, Peru, Philippines, Poland, Portugal, Qatar, Romania, Russian Federation, Rwanda, Saint Kitts and Nevis, Saint Lucia, Saint Vincent and the Grenadines, San Marino, Sao Tome and Principe, Senegal, Sierra Leone, Singapore, Slovak Republic (Slovakia), Slovenia, Solomon Islands, South Africa, Spain, Sri Lanka, Sudan, Suriname, Swaziland, Sweden, Switerland, Syrian Arab Republic (Syria), Taiwan, Tajikistan, Tanzania, Thailand, Togo, Trinidad and Tobago, Tunisia, Turkey, Turkmenistan, Uganda, Ukraine, United Arab Emirates, United Kingdom (including Isle of Man), United States Of America (including all territories and possessions, including the Commonwealth of Puerto Rico), Uruguay, Uzbekistan, Venezuela, Vietnam, Yugoslavia (including Serbia and Montenegro), Zambia or Zimbabwe.

8. The communication system as claimed in claim 1 wherein said secondary language is any human language which can be represented audibly.

9. The communication system as claimed in claim 8 wherein said secondary language includes any the one of the official languages of Albania, Algeria, Angola, Antigua and Barbuda, Argentina, Armenia, Australia, Austria, Azerbaijan, Bahamas, Bahrain, Bangladesh, Barbados, Belaus, Belgium, Belize, Benin, Bolivia, Bosnia and Herzegovina, Botswana, Brazil, Bulgaria, Bukina Faso, Burundi, Cambodia, Cameroon, Canada, Central African Republic, Chad, Chile, China, Colombia, Congo, Congo, Democratic Republic of, Costa Rica, Cote d'Ivoire, Croatia, Cuba, Cyprus, Czech Republic, Denmark (including Faroe Islands), Djibouti, Dominica, Dominican Republic, Ecuador, Egypt, El Salvador, Estonia, Equatorial Guinea, Finland, Fiji, France (including Overseas Departments and Territories), Gabon, Gambia, Georgia, Germany, Ghana, Greece, Grenada, Guatemala, Guinea, Guinea-Bissau, Guyana, Haiti, Holy See (The Vatican), Honduras, Hong Kong, China, Hungary, Iceland, India, Indonesia, Iran, Islamic Republic of, Iraq, Ireland, Israel, Italy, Jamaica, Japan, Jordan, Kakakahstan, Kenya, Korea, Democratic People's Republic of, Korea, Republic of (South Korea), Kuwait, Kyrgyzstan, Laos, Lebanon, Lesotho, Liberia, Libya, Liechtenstein, Lithuania, Luxembourg, Macau, Macedonia (former Yugoslavia), Madagascar, Malawi, Malaysia, Maldives, Mali, Malta, Mauritania, Mauritius, Mexico, Moldova, Monaco, Mongolia, Morocco, Mozambique, Myanmar, Namibia, The Netherlands, New Zealand, Nicaragua, Niger, Nigeria, Norway, Oman, Pakistan, Panama, Papua New Guinea, Paraguay, Peru, Philippines, Poland, Portugal, Qatar, Romania, Russian Federation, Rwanda, Saint Kitts and Nevis, Saint Lucia, Saint Vincent and the Grenadines, San Marino, Sao Tome and Principe, Senegal, Sierra Leone, Singapore, Slovak Republic (Slovakia), Slovenia, Solomon Islands, South Africa, Spain, Sri Lanka, Sudan, Suriname, Swaziland, Sweden, Switerland, Syrian Arab Republic (Syria), Taiwan, Tajikistan, Tanzania, Thailand, Togo, Trinidad and Tobago, Tunisia, Turkey, Turkmenistan, Uganda, Ukraine, United Arab Emirates, United Kingdom (including Isle of Man), United States Of America (including all territories and possessions, including the Commonwealth of Puerto Rico), Uruguay, Uzbekistan, Venezuela, Vietnam, Yugoslavia (including Serbia and Montenegro), Zambia or Zimbabwe.

10. A method of using the communication system as defined in claim 1 including the following steps:
(a) sending information in an audible format to said information receiving means;
(b) converting said information from a primary language to a secondary language via said information converting means; and
(c) forwarding said information in said audible format and said secondary language to said information recipient via said information forwarding means.
